(19) United States
(12) Patent Application Publication
(10) Pub. No.: US 2018/0063380 A1
(43) Pub. Date: Mar. 1, 2018

(54) IMAGE PROCESSING DEVICE

(71) Applicant: OLYMPUS CORPORATION, Tokyo (JP)

(72) Inventor: Hiromi SHIDA, Tokyo (JP)

(73) Assignee: OLYMPUS CORPORATION, Tokyo (JP)

(21) Appl. No.: 15/801,449

(22) Filed: Nov. 2, 2017

Related U.S. Application Data
(63) Continuation of application No. PCT/JP2015/066661, filed on Jun. 10, 2015.

(51) Int. Cl. H04N 1/60; G06T 7/136; G06T 5/40

(52) U.S. Cl. CPC H04N 1/60; G06T 2207/20104; G06T 5/40; G06T 7/136

(57) ABSTRACT

An image processing device including: a luminance obtaining unit that obtains the luminance values of pixels in a region of interest that is at least part of an input image; and a luminance correcting unit that corrects the luminance values of the pixels on the basis of the luminance values obtained by the luminance obtaining unit, such that the distribution range of the luminance values of the pixels in the region of interest is narrowed while maintaining the magnitude relationship between the luminance values in the image.

### CROSS-REFERENCE TO RELATED APPLICATIONS

This is a continuation of International Application PCT/JP2015/066661, with an international filing date of Jun. 10, 2015, which is hereby incorporated by reference herein in its entirety.

### TECHNICAL FIELD

The present invention relates to an image processing device.

### BACKGROUND ART

In the related art, there are known image processing devices for correcting the colors of respective pixels on the basis of the relationships between the color of a pixel of interest in an image and the colors of pixels surrounding the pixel of interest (for example, see PTL 1). The apparent color of the pixel of interest that an observer perceives varies according to the colors of the surrounding pixels. By taking such an illusion into account, it is possible to appropriately evaluate the color of the pixel of interest.

### CITATION LIST

### Patent Literature

PTL 1 Japanese Unexamined Patent Application, Publication No. 2008-98932

### SUMMARY OF INVENTION

The present invention provides an image processing device including: a luminance obtaining unit that obtains the luminance values of pixels in a region of interest that is at least part of an input image; and a luminance correcting unit that corrects the luminance values of the pixels on the basis of the luminance values obtained by the luminance obtaining unit, wherein the luminance correcting unit corrects the luminance values of the pixels such that a distribution range of the luminance values of the pixels in the region of interest is narrowed while maintaining the magnitude relationship between the luminance values in the image.

### BRIEF DESCRIPTION OF DRAWINGS

FIG. 1 is a block diagram showing the functions of an image processing device according to one embodiment of the present invention.

FIG. 2A is a luminance value histogram of an original image, created by a luminance correcting unit.

FIG. 2B is the histogram shown in FIG. 2A corrected by the luminance correcting unit.

FIG. 3 is a graph showing the relationship between the luminance value and the apparent chroma.

FIG. 4 is a block diagram showing a modification of the image processing device shown in FIG. 1.

FIG. 5 is a luminance value histogram for explaining a modification of luminance-value correction processing performed by the luminance correcting unit.

FIG. 6 is a luminance value histogram for explaining another modification of the luminance-value correction processing performed by the luminance correcting unit.

FIG. 7 is a tone curve for explaining still another modification of the luminance-value correction processing performed by the luminance correcting unit.

FIG. 8 is a gamma curve for explaining still another modification of the luminance-value correction processing performed by the luminance correcting unit.

FIG. 9 is a luminance value histogram for explaining still another modification of the luminance-value correction processing performed by the luminance correcting unit.

FIG. 10 is a block diagram showing the functions of still another modification of the image processing device shown in FIG. 1.

### DESCRIPTION OF EMBODIMENT

An image processing device 1 according to one embodiment of the present invention will be described below with reference to the drawings.

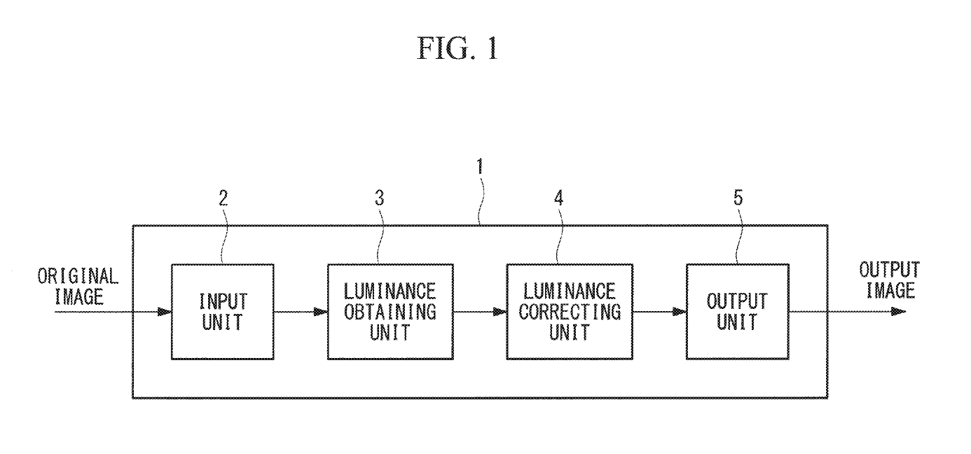

As shown in FIG. 1, the image processing device 1 of this embodiment is provided with: an input unit 2 to which an original image is input from outside; a luminance obtaining unit 3 that calculates the luminance values of the original image; a luminance correcting unit 4 that corrects the luminance values of the original image; and an output unit 5 that outputs, to the outside, the original image in which the luminance values have been corrected (corrected image).

The image processing device 1 is a general purpose computer, for example, and is provided with: a central processing unit (CPU); a main storage unit, such as a RAM; and an auxiliary storage unit. The auxiliary storage unit is a non-transitory computer-readable storage medium and stores an image processing program. The CPU calls the image processing program from the auxiliary storage unit to the main storage unit and executes the image processing program, thereby realizing the functions of the luminance obtaining unit 3 and the luminance correcting unit 4. Alternatively, the image processing device 1 may be provided with dedicated hardware (ASIC) that performs processing, to be described later, performed by the luminance obtaining unit 3 and the luminance correcting unit 4.

The input unit 2 is connected to, for example, an observation device (not shown), such as a microscope or an endoscope, so that an original image is input from the observation device to the image processing device 1 via the input unit 2.

The output unit 5 is connected to a display unit (not shown), for example, and outputs to the display unit, as an output image, the unprocessed original image or a corrected image that has been processed by the luminance correcting unit 4.

The luminance obtaining unit 3 obtains, from the original image, the luminance values of all pixels in a predetermined region of interest in the original image, and selects the minimum luminance value Vmin and the maximum luminance value Vmax among the obtained luminance values. Next, the luminance obtaining unit 3 calculates the ratio Vmax/Vmin of the maximum luminance value Vmax to the minimum luminance value Vmin.

A description will be given below of a case in which the entire region of the original image is set as a region of interest. However, the region of interest may be a partial region in the original image, and, for example, a central region in the original image may be set as a region of interest.

When the value of the ratio Vmax/Vmin, which is calculated by the luminance obtaining unit 3, is greater than 2, the luminance correcting unit 4 performs, on the original image, luminance-value correction processing, to be described later. On the other hand, when the value of the ratio Vmax/Vmin, which is calculated by the luminance obtaining unit 3, is equal to or less than 2, the luminance correcting unit 4 does not perform luminance-value correction processing on the original image.

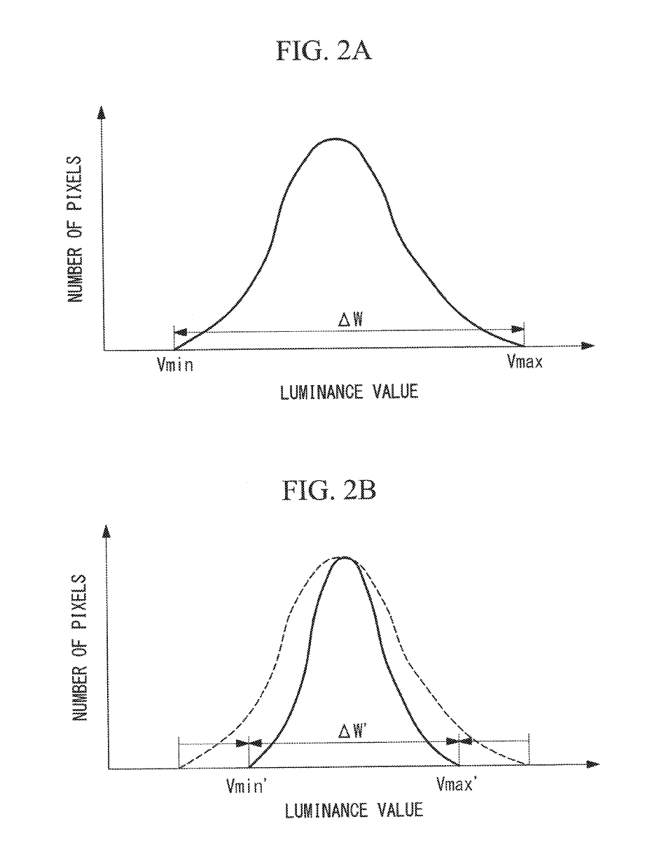

In the luminance-value correction processing, the luminance correcting unit 4 creates a histogram of the luminance values of the all pixels in the original image, as shown in FIG. 2A. Next, the luminance correcting unit 4 calculates a distribution width ΔW′=Vmax′−Vmin′ in which the ratio Vmax′/Vmin′ becomes equal to or less than 2, on the basis of the maximum luminance value Vmax and the minimum luminance value Vmin, and compresses the distribution width ΔW=Vmax/Vmin of the luminance values in the histogram down to the distribution width ΔW′, as indicated by a solid line in FIG. 2B. Vmax′ is the maximum luminance value obtained after correction and is less than Vmax. Vmin′ is the minimum luminance value obtained after correction and is greater than Vmin. Accordingly, the luminance correcting unit 4 corrects the luminance values of the original image such that the luminance-value distribution range obtained after correction becomes narrower than that obtained before correction, while maintaining the magnitude relationship between the luminance values in the original image. The luminance correcting unit 4 replaces the luminance values of the respective pixels of the original image with the corrected luminance values, thereby generating a corrected image, and sends the corrected image to the output unit 5.

Next, the operation of the thus-configured image processing device 1 will be described.

When an original image is input to the image processing device 1 from the observation device via the input unit 2, first, the luminance obtaining unit 3 calculates the ratio Vmax/Vmin of the original image. The ratio Vmax/Vmin is a value indicating the magnitude of the difference between the luminance values in the original image. Next, the luminance correcting unit 4 determines the need for the correction processing of the luminance values of the original image on the basis of the ratio Vmax/Vmin.

If the difference between the luminance values in the original image is small, and the ratio Vmax/Vmin is equal to or less than 2, it is determined that the correction processing is not necessary, and the original image input to the image processing device 1, which remains unprocessed, is output to the display unit via the output unit 5 and is displayed on the display unit.

On the other hand, if the difference between the luminance values in the original image is large, and the ratio Vmax/Vmin is greater than 2, the luminance correcting unit 4 corrects the luminance values of the original image such that the ratio Vmax′/Vmin′ becomes equal to or less than 2. In this case, a corrected image is output to the display unit via the output unit 5 and is displayed on the display unit.

Here, the relationship between chroma and luminance values of an image will be described.

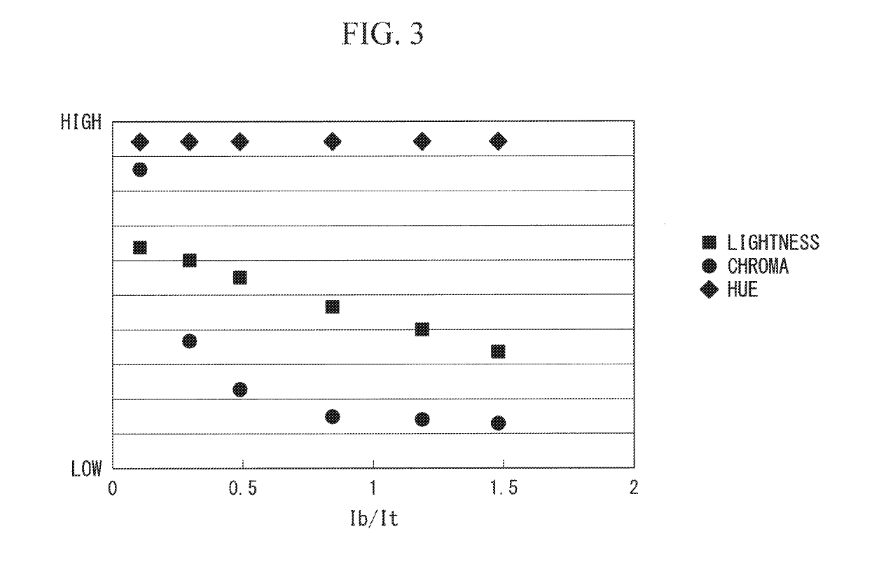

Color has three components, i.e., lightness, chroma, and hue. FIG. 3 is a graph showing the relationship between: the brightness ratio of an observation target pixel (target) in an image and surrounding pixels (background) of the target; and apparent lightness, chroma, and hue of the target that an observer who observes the image perceives. The horizontal axis shows the ratio Ib/It of the background luminance value Ib to the target luminance value It, and the vertical axis shows apparent lightness, chroma, and hue.

As shown in FIG. 3, in the range where the ratio Ib/It is less than 0.5, the influence of the brightness of the background on the apparent chroma of the target is large. Even if the actual chroma is the same, the apparent chroma of the target tends to be higher as the background is darker. In contrast to this, in the range where the ratio Ib/It is equal to or greater than 0.5, the influence of the brightness of the background on the apparent chroma of the target is small, and the apparent chroma of the target is substantially constant with respect the actual chroma of the target, irrespective of the brightness of the background.

In this embodiment, the ratio Vmax/Vmin or Vmax′/Vmin′ of an output image to be displayed on the display unit is equal to or less than 2. Specifically, at every target in the output image, the ratio Ib/It becomes always equal to or greater than 0.5. Therefore, when the observer compares color between a plurality of desired locations in the output image displayed on the display unit, it is possible for the observer to recognize colors having equal actual chroma to be colors having equal chroma and to recognize colors having different actual chromas to be colors having different chromas.

In this way, if the difference between the luminance values in the original image is large, the luminance values are corrected such that the luminance-value distribution range is narrowed to make the ratio Vmax′/Vmin′ become equal to or less than 2. Therefore, there is an advantage in that it is possible to provide the observer with an output image in which the actual chroma of each pixel can be visually evaluated with accuracy. Furthermore, since processing performed by the image processing device 1 is merely simple luminance-value calculation, there is an advantage in that the time required from input of an original image to output of an output image is short.

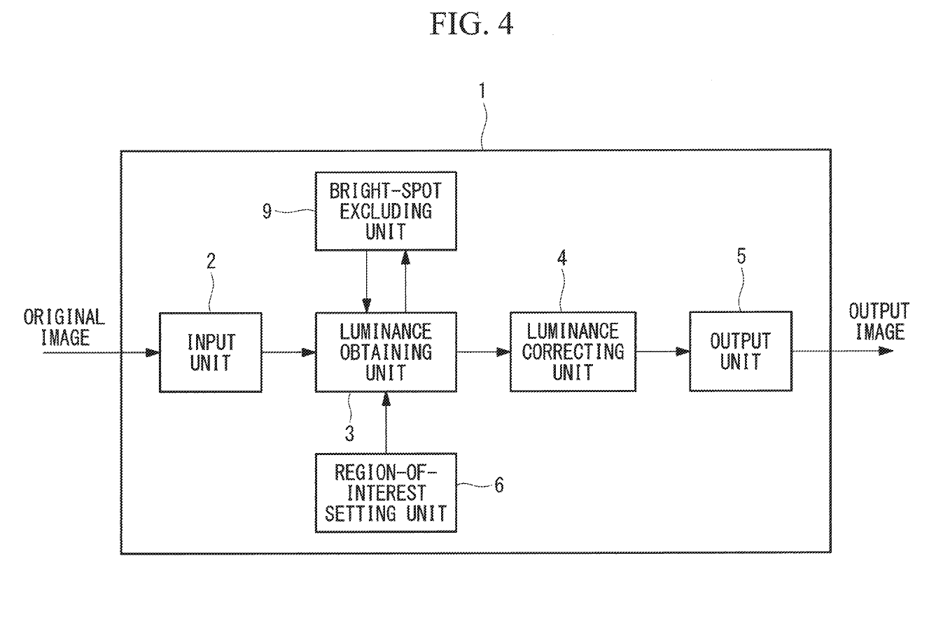

Note that, in this embodiment, as shown in FIG. 4, a region-of-interest setting unit 6 that sets a region of interest in the original image may be further provided, and the luminance correcting unit 4 may correct the luminance values of the original image such that the ratio Vmax′/Vmin′ at the region of interest set by the region-of-interest setting unit 6 becomes equal to or less than 2.

In this case, the observer can specify, as the region of interest, a desired region in the original image displayed on the display unit by using input devices (not shown), such as a touch panel and a stylus pen, provided for the display unit. The region-of-interest setting unit 6 obtains, from the input devices, position information about the region specified by the operator and sets the region of interest with respect to the original image on the basis of the obtained position information. Accordingly, it is possible to set a region of interest that is more suitable for the purpose of observation by the observer.

Furthermore, in this embodiment, as shown in FIG. 4, it is also possible to further provide a bright-spot excluding unit 9 that excludes luminance values that are equal to or greater than a predetermined threshold, among the luminance values of the original image obtained by the luminance obtaining unit 3. In this case, the luminance obtaining unit 3 selects the minimum luminance value Vmin and the maximum luminance value Vmax from the remaining luminance values after the luminance values that are equal to or greater than the predetermined threshold are excluded, and the luminance correcting unit 4 creates a histogram by using the remaining luminance values after the luminance values that are equal to or greater than the predetermined threshold are excluded.

Due to dust existing on a subject, in some cases, a bright spot having a luminance value that is much greater than the surrounding region occurs in an original image. In such cases, the maximum luminance value Vmax is selected from the luminance values obtained after the luminance value of the bright spot is excluded, thereby making it possible to perform more accurate correction of the luminance values, in the luminance correcting unit 4.

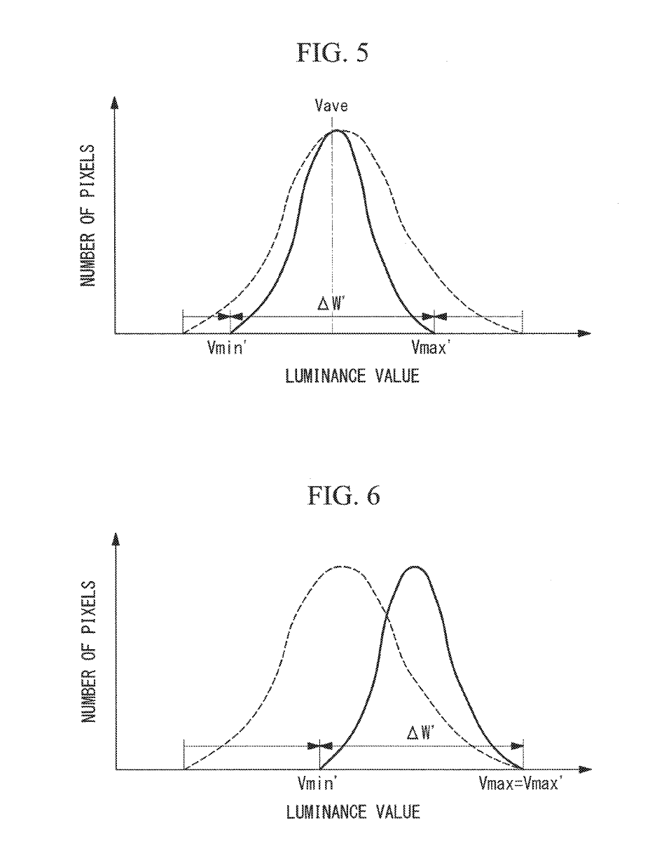

Furthermore, in this embodiment, as shown in FIG. 5, the luminance correcting unit 4 may calculate an average luminance value Vave in the region of interest from the luminance values obtained by the luminance obtaining unit 3 and may compress the distribution width AW of the luminance values in the histogram to the distribution width ΔW′, with the calculated average luminance value Vave serving as the center. In FIG. 5, the dashed line shows the histogram of the original image, and the solid line shows the histogram of the corrected image.

By doing so, because the average luminance value Vave of the original image and the average luminance value Vave′ of the corrected image are equal, it is possible to prevent a fluctuation in brightness of the corrected image with respect to the original image.

Specifically, the luminance correcting unit 4 multiplies the luminance values that are distributed on the high-luminance side of the average luminance value Vave by a compression coefficient α and multiplies the luminance values that are distributed on the low-luminance side of the average luminance value Vave by a compression coefficient β. The compression coefficients α and β are calculated by the following expressions.

Compression coefficient α=predetermined distribution width×0.5/(maximum luminance value Vmax−average luminance value Vave)

Compression coefficient β=predetermined distribution width×0.5/(average luminance value Vave−minimum luminance value Vmin)

Alternatively, as shown in FIG. 6, the luminance correcting unit 4 may compress the distribution width ΔW in the histogram so as to correct the luminance values that are smaller than the maximum luminance value Vmax to become larger luminance values while maintaining the value of the maximum luminance value Vmax. In FIG. 6, the dashed line shows the histogram of the original image, and the solid line shows the histogram of the corrected image. In this case, the brightness of the corrected image is not reduced with respect to the original image.

Specifically, a luminance value V′ of the corrected image is obtained from a luminance value V of the original image according to the following expression.

V′=maximum luminance value Vmax−(maximum luminance value Vmax−V)×compression coefficient γ

Furthermore, in this embodiment, although the luminance correcting unit 4 corrects the luminance values by compressing the distribution width ΔW′ of the luminance values in the histogram, the luminance-value correction method is not limited thereto, and another method can be used.

For example, as shown in FIG. 7, the luminance values may be corrected by changing a tone curve of the original image such that the minimum luminance value Vmin and the maximum luminance value Vmax fall within a luminance range in which the ratio Vmax′/Vmin′ becomes equal to or less than 2. In FIG. 7, the dashed line shows the tone curve of the original image, and the solid line shows the tone curve of the corrected image. The changed tone curve may be a straight line or may be an arc-shaped or S-shaped curve.

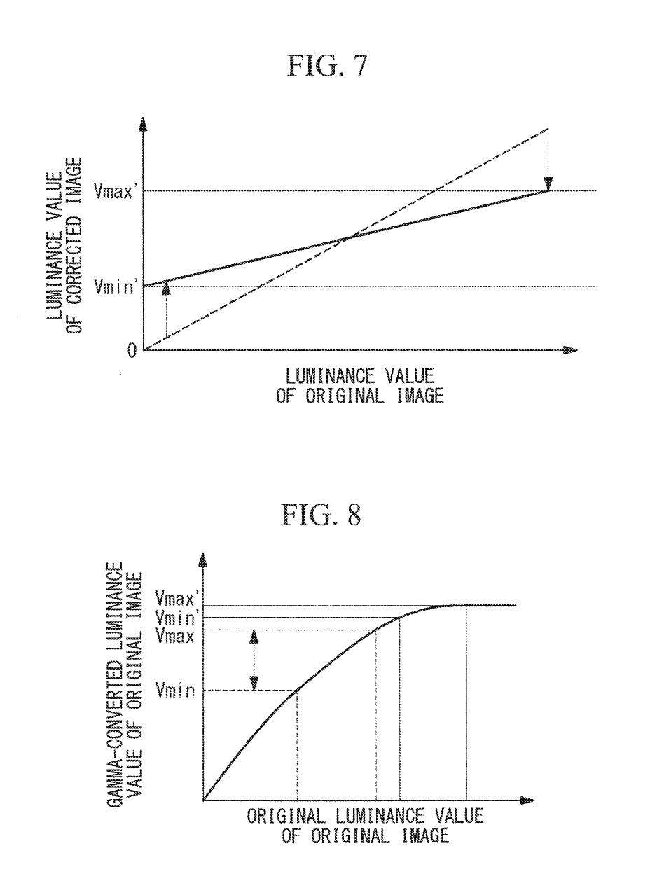

Alternatively, in a case in which a gamma curve is used for the original image, as shown in FIG. 8, the luminance correcting unit 4 may use the characteristics of this gamma curve and correct the luminance values of the original image by shifting the overall luminance values of the original image to a luminance range in which the ratio Vmax′/Vmin′ becomes equal to or less than 2. Alternatively, the luminance correcting unit 4 may correct the luminance values by adjusting a gain of the gamma curve of the original image.

By doing so, a corrected image can be generated merely through simple image processing.

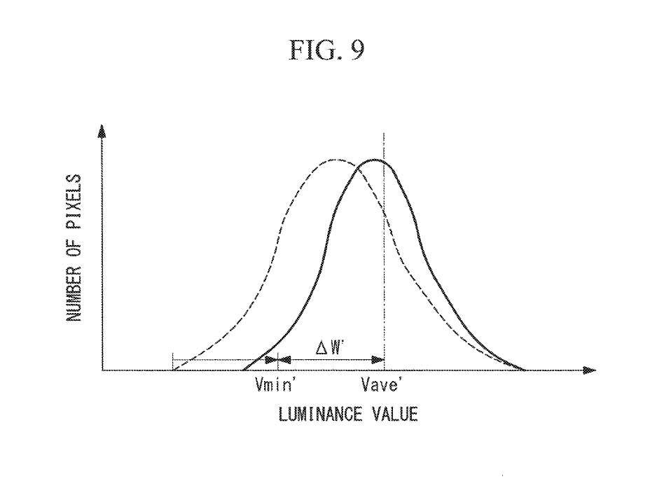

Furthermore, in this embodiment, although the luminance correcting unit 4 corrects the luminance values of the original image such that both the minimum luminance value Vmin′ and the maximum luminance value Vmax′ in a region of interest fall within a luminance range in which the ratio Vmax′/Vmin′ becomes equal to or less than 2, instead of this, as shown in FIG. 9, the luminance correcting unit 4 may correct the luminance values of the original image such that the minimum luminance value Vmin′ and the average luminance value Vave′ in a region of interest fall within a luminance range in which the ratio Vmax′/Vmin′ becomes equal to or less than 2. In FIG. 9, the dashed line shows the histogram of the original image, and the solid line shows the histogram of the corrected image. In this case, it is preferred that the observer be able to set, as the region of interest, a desired region in the original image by means of the region-of-interest setting unit 6, shown in FIG. 4.

By doing so, it is possible to provide an output image in which the actual chroma can be visually evaluated with accuracy.

Specifically, the luminance correcting unit 4 calculates a compression coefficient ε on the basis of the average luminance value Vave and the minimum luminance value Vmin in the region of interest and calculates a gradation value V′ of the corrected image according to the following expressions.

Compression coefficient ε=(average luminance value Vave/2)/(average luminance value Vave−minimum luminance value Vmin)

V′=(V−Vave)×ε+Vave

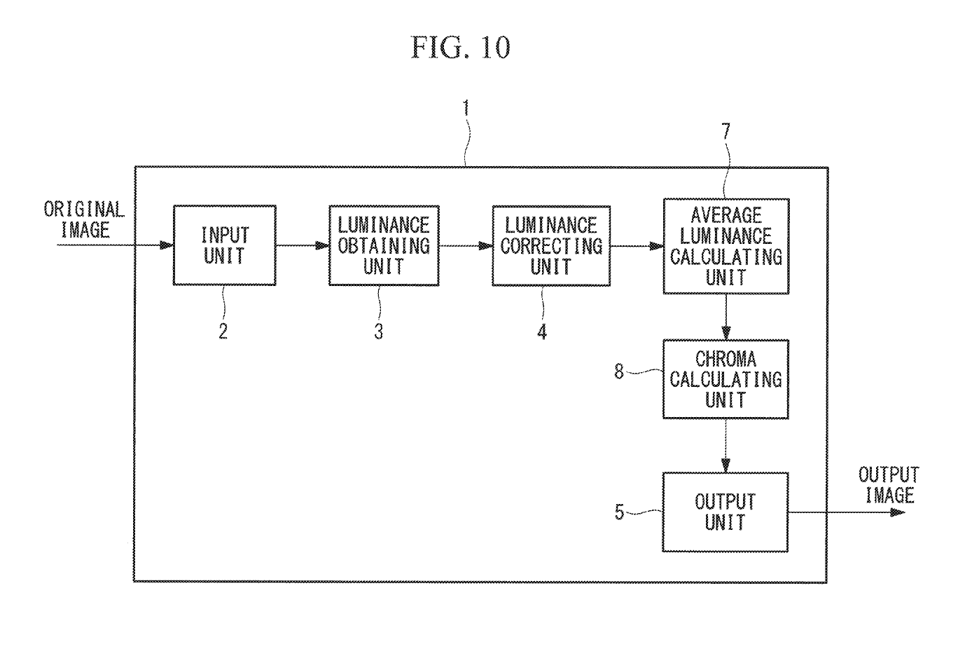

Furthermore, in this embodiment, as shown in FIG. 10, it is also possible to further include an average luminance calculating unit 7 that calculates an average luminance value of the region of interest in the corrected image, and a chroma calculating unit 8 that calculates the chroma of each pixel at least in the region of interest in the corrected image on the basis of the average luminance value calculated by the average luminance calculating unit 7.

The average luminance calculating unit 7 calculates, as an average luminance value, the average of the luminance values of all pixels in the region of interest in the corrected image.

The chroma calculating unit 8 uses, for example, CIECAM (CIE color appearance model) 02 and calculates, as the chroma of each pixel in the corrected image, colorfulness, which is the actual chroma (absolute amount), and the values of chroma and saturation, which are apparent chroma (relative amounts). Accordingly, the chroma of each pixel in the corrected image can be evaluated not only by its appearance but also quantitatively.

Here, the luminance value of the background is required for calculating the chroma of each pixel using CIECAM02. In calculating the chroma of all pixels, the chroma calculating unit 8 uses the average luminance value calculated by the average luminance calculating unit 7, as the luminance value of the background. Because the difference between the luminance values in the corrected image has been reduced, even when the average luminance value is used instead of the actual luminance value, the chroma of each pixel can be accurately calculated. Furthermore, the amount of calculation can be significantly reduced.

The chroma calculating unit 8 may color-code the pixels of the corrected image for the respective calculated chroma values, thereby creating a chroma map that indicates the spatial distribution of the chroma in the corrected image, and may output the chroma map to the display unit via the output unit 5. By doing so, the observer can visually and easily recognize the distribution of actual chroma and/or apparent chroma of the corrected image.

In a case in which the original image is a biological image that is acquired by capturing a living body, the chroma calculating unit 8 may extract pixels having chroma equal to or greater than a predetermined threshold. Markers for indicating pixels corresponding to the pixels extracted by the chroma calculating unit 8 are put in the corrected image.

Blood has relatively high chroma compared with fat or blood vessels. Therefore, it is possible to extract a bleeding area in the living body on the basis of the chroma and to provide the observer with a corrected image in which a marker is put on the bleeding area.

From the above-described embodiments and modifications thereof, the following aspects of the invention are derived.

The present invention provides an image processing device including: a luminance obtaining unit that obtains the luminance values of pixels in a region of interest that is at least part of an input image; and a luminance correcting unit that corrects the luminance values of the pixels on the basis of the luminance values obtained by the luminance obtaining unit, wherein the luminance correcting unit corrects the luminance values of the pixels such that a distribution range of the luminance values of the pixels in the region of interest is narrowed while maintaining the magnitude relationship between the luminance values in the image.

According to the present invention, the luminance obtaining unit obtains the luminance values of pixels in a region of interest in an image, and the luminance correcting unit corrects the luminance values of the image such that the luminance values of the all pixels in the region of interest are distributed in a predetermined range. Accordingly, an image in which the difference between the luminance values in the region of interest has been reduced is acquired. The apparent chroma of each pixel in an image depends on the luminance values of pixels surrounding that pixel. Therefore, in the image corrected by the luminance correcting unit, the chroma of each pixel in the region of interest can be visually evaluated with accuracy while reducing the influence caused by the luminance values of the surrounding pixels. Furthermore, since processing required for correcting an image is merely simple luminance-value calculation, the processing time is reduced.

In the above-described invention, the luminance correcting unit may correct the luminance values of the pixels such that the maximum luminance value becomes two times or less of the minimum luminance value in the region of interest.

By doing so, the relationship between the actual chroma and the apparent chroma at each pixel in the region of interest becomes constant without depending on the luminance values of the surrounding pixels. Therefore, the chroma of each pixel in the region of interest can be evaluated with more accuracy.

The above-described invention may further include: an average luminance calculating unit that calculates an average luminance value of the region of interest in which the luminance values have been corrected by the luminance correcting unit; and a chroma calculating unit that calculates the chroma of the pixels of which the luminance values have been corrected by the luminance correcting unit, on the basis of the average luminance value calculated by the average luminance calculating unit.

By doing so, the chroma of each pixel in the image in which the luminance values have been corrected can be quantitatively evaluated.

The above-described invention may further include a bright-spot excluding unit that excludes a luminance value that is equal to or greater than a predetermined threshold, from the luminance values obtained by the luminance obtaining unit, wherein the luminance correcting unit may correct the luminance values of the pixels on the basis of the luminance values remaining after the luminance value that is equal to or greater than the predetermined threshold is excluded by the bright-spot excluding unit.

By doing so, if a high-luminance bright spot, which is caused by dust etc. existing on a subject, exists in the region of interest in the image, the luminance value at the bright spot is excluded from the luminance values obtained by the luminance obtaining unit. Accordingly, the luminance values of the image can be corrected more appropriately.

The above-described invention may further include a region-of-interest setting unit that sets the region of interest in the input image.

By doing so, a desired region in the image can be set as a region of interest.

### REFERENCE SIGNS LIST

1 image processing device
3 luminance obtaining unit
4 luminance correcting unit
6 region-of-interest setting unit
7 average luminance calculating unit
8 chroma calculating unit
9 bright-spot excluding unit

1. An image processing device comprising:
a luminance obtaining unit that obtains the luminance values of pixels in a region of interest that is at least part of an input image; and
a luminance correcting unit that corrects the luminance values of the pixels on the basis of the luminance values obtained by the luminance obtaining unit,
wherein the luminance correcting unit corrects the luminance values of the pixels such that a distribution range of the luminance values of the pixels in the region of interest is narrowed while maintaining the magnitude relationship between the luminance values in the image.

2. An image processing device according to claim 1, wherein the luminance correcting unit corrects the luminance values of the pixels such that the maximum luminance value becomes two times or less of the minimum luminance value in the region of interest.

3. An image processing device according to claim 1, further comprising:
an average luminance calculating unit that calculates an average luminance value of the region of interest in which the luminance values have been corrected by the luminance correcting unit; and
a chroma calculating unit that calculates the chroma of the pixels of which the luminance values have been corrected by the luminance correcting unit, on the basis of the average luminance value calculated by the average luminance calculating unit.

4. An image processing device according to one of claims 1, further comprising a bright-spot excluding unit that excludes a luminance value that is equal to or greater than a predetermined threshold, from the luminance values obtained by the luminance obtaining unit,
wherein the luminance correcting unit corrects the luminance values of the pixels on the basis of the luminance values remaining after the luminance value that is equal to or greater than the predetermined threshold is excluded by the bright-spot excluding unit.

5. An image processing device according to 1, further comprising a region-of-interest setting unit that sets the region of interest in the input image.
